(19) United States
(12) Patent Application Publication
(10) Pub. No.: US 2018/0090126 A1
(43) Pub. Date: Mar. 29, 2018

(54) VOCAL OUTPUT OF TEXTUAL COMMUNICATIONS IN SENDERS VOICE

(71) Applicant: Lenovo (Singapore) Pte. Ltd., Singapore (SG)

(72) Inventors: Nathan J. Peterson, Oxford, NC (US); Joshua Neil Novak, Wake Forest, NC (US); Nicholas Richard Roberts, Cary, NC (US); Brian Jules Jaeger, Wake Forest, NC (US)

(21) Appl. No.: 15/276,223

(22) Filed: Sep. 26, 2016

(51) Int. Cl. G10L 13/033; G10L 13/08; G10L 13/04

(52) U.S. Cl. CPC G10L 13/033; G10L 13/04; G10L 13/08

(57) ABSTRACT

One embodiment provides a method, including: receiving, at an information handling device, an indication to produce voice output; identifying, using a processor, a voice profile; generating, using a processor, the voice output, said voice output being tuned based on the voice profile; and providing, using a speaker, the voice output. Other aspects are described and claimed.

### BACKGROUND

Information handling devices (“devices”), for example cell phones, smart phones, tablet devices, laptop computers, and the like permit users to communicate with other users by sending and receiving textual data, e.g., text messages, emails, notifications, etc. Advances in technology have enabled the textual data received on these devices to be audibly output to a user (e.g., through text to speech software) by a pre-recorded voice.

### BRIEF SUMMARY

In summary, one aspect provides a method, comprising: receiving, at an information handling device, an indication to produce voice output; identifying, using a processor, a voice profile; generating, using a processor, the voice output, said voice output being tuned based on the voice profile; and providing, using a speaker, the voice output.

Another aspect provides an information handling device, comprising: a processor; a speaker; a memory device that stores instructions executable by the processor to: receive an indication to produce voice output; identify a voice profile; generate the voice output, said voice output being tuned based on the voice profile; and provide the voice output.

A further aspect provides a product, comprising: a storage device that stores code, the code being executable by a processor and comprising: code that receives an indication to produce voice output; code that identifies a voice profile; code that generates the voice output, said voice output being tuned based on the voice profile; and code that provides the voice output.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing text-to-speech output in a sender's voice.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, text-to-speech software employed on devices (e.g., Siri® for Apple® or Cortana® for Windows®) may identify a segment of text data (e.g., by comparing to an accessible word bank), associate that segment with a pre-recorded vocal output, and subsequently transmit (e.g., through a speaker) the pre-recorded vocal output corresponding to the identified text segment to a user. For example, when a user receives a text message from another user that contains the greeting, “Hello,” a program may identify the word and subsequently output a pre-recording of the word, “Hello,” to the user.

Text-to-speech software may be helpful to users who find themselves in situations where they desire to learn the contents of a received textual communication (e.g., text message, e-mail, social media notification, etc.) but they are in an environment where they are unable to visually inspect the textual communication. A common example pertains to when a user is driving and cannot take their attention off of the road to read a received text message.

Conventional text-to-speech programs, however, contain several issues pertaining to the efficiency and clarity of the vocal output. One issue, for example, is that the pre-recorded voice associated with the vocal output may only be programmed to vocally output received textual communications in a limited number of dialects (e.g., American English, British English, Australian English, etc.). Individuals who are not accustomed to hearing some or all of the dialect options associated with the pre-recorded voice may find it difficult to understand the vocal output. Additionally, another issue is that some text-to-speech programs do not identify and vocally output the name of the sender of the textual communication (i.e., vocally output the contact name, if available, associated with the textual communication). The programs that do may not be able to properly pronounce the name of the sender. For example, if a sender of a text message has an uncommon name, the program may not be able to determine a vocal output that is associated with that name. Alternatively, a program may try to associate vocal output with the uncommon name; however, because there is no direct match between the senders' name and any stored vocal output, an improper pronunciation of the sender's name results. Both situations would result in user confusion because the user would not be able to immediately identify the sender of the textual communication. Furthermore, it is a regular complaint by users that the vocal output from conventional text-to-speech programs is too robotic and does not provide users with a personal communication experience due to the use of pre-recorded, stock audio for all vocal output.

Accordingly, an embodiment provides a method of outputting the contents of received textual communications in a voice associated with the sender of the textual communication. In an embodiment, a voice profile, corresponding to a user, may be generated using voice input from the user. In an embodiment, the voice profile may be associated with the textual communications sent by the user who provided voice input to the voice profile. Therefore, when textual communications from the user are received, a device may vocally output the contents of the textual communication in the user's voice using the generated voice profile. Such a method enables a user, when using text-to-speech software, to immediately identify the sender of a textual communication based upon the sound of the sender's voice. Additionally, an embodiment provides the user with a better use experience, i.e., an experience that is representative of in-person conversation.

In an embodiment, a voice profile for a second user (e.g., a phone contact) may be generated on a first user's device by using voice input from the second user. In an embodiment, a voice profile for a first user may be generated on a first user's device and shared with other users. In an embodiment, the voice profile may be updated based upon subsequent voice inputs.

The illustrated example embodiments will be best understood by reference to the figures. The following description is intended only by way of example, and simply illustrates certain example embodiments.

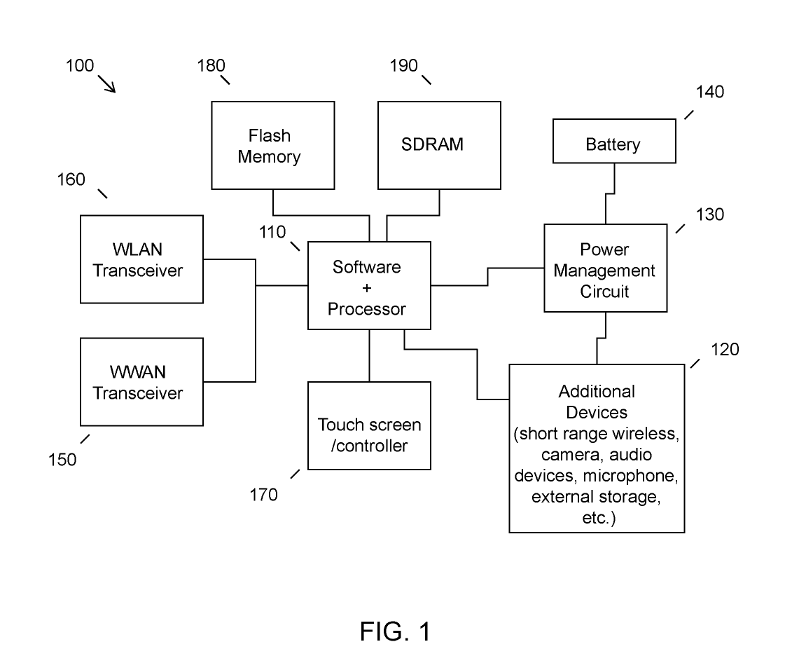

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

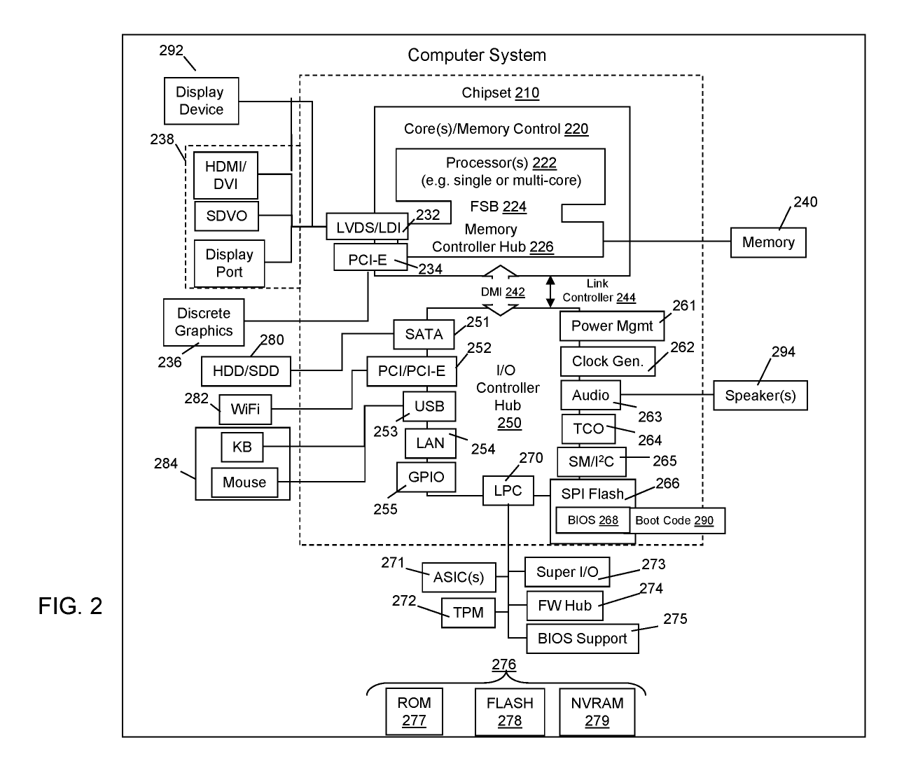

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which enable users to perform text-to-speech functions. For example, the circuitry outlined in FIG. 1 may be implemented in a tablet or smart phone embodiment, whereas the circuitry outlined in FIG. 2 may be implemented in a personal computer embodiment.

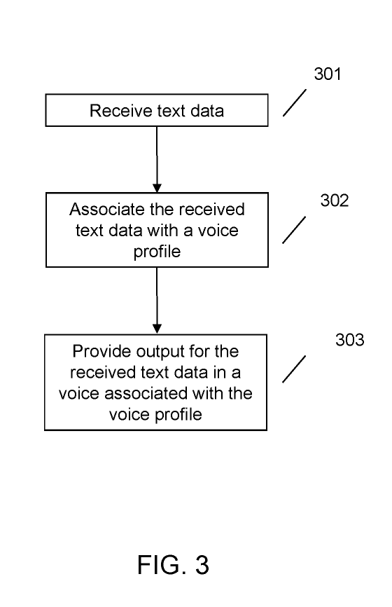

Referring now to FIG. 3, at 301, an embodiment may receive text data on a device. In an embodiment, a user may receive textual communications from another user (“sender”) that may include text messages, emails, social media notifications, etc. In an embodiment, an identity profile that is associated with the sender may be created by the user. The identity profile may include details about the sender, such as, for example, the sender's first and last name. In an embodiment, when a textual communication is received from the sender, the sender's identity (e.g., first and last name) may appear concurrently with the body of the text message. For example, a user may create an identity profile for their friend, “Meghan Smith,” so that when the user's friend sends the user a text message, “Meghan Smith” may appear above the body of the text message, denoting the identity of the sender. In an embodiment, the identity profiles of different senders may be stored in list form (e.g., a contact list). The list may be stored at a storage location accessible either locally (e.g., on the device) or at another storage location (e.g., cloud storage).

After a textual communication is received from a sender, an embodiment may associate, at 302, the received text data with a voice profile. In an embodiment, the voice profile may comprise learned aspects of a user's voice, (e.g. voice pitch, voice tone, voice accent, etc.). An embodiment may associate textual communications received from a sender with their voice profile so that the textual communications may be vocally output (e.g., through text-to-speech software) in the sender's voice, e.g., using a tuned speech output model that has been adjusted using the learned aspects of the sender's voice.

In an embodiment, a voice profile may be generated for each sender in a user's contact list. In an embodiment, the voice profile may be generated automatically or only generated upon user designation. For example, an embodiment may automatically generate a voice profile for each new sender that a user has created an identity profile for. Alternatively, for example, a user may toggle a button (e.g., in the identity profile of a sender) designating that a voice profile should be generated for an individual user. In another embodiment, if a user receives a textual communication from a sender that is unknown (i.e., a sender who the user has not created an identity profile for), the user may be presented with an option (e.g., through a dialog box) that queries the user whether they want to generate a voice profile for the unknown sender. In an embodiment, the voice profile may be associated with the unknown sender's telephone number.

In an embodiment, the voice profile may be updated based upon subsequent voice inputs. As a particular voice profile gets updated, and more sample data is available for the sender's voice characteristics, an embodiment will be able to more accurately duplicate the voice of the user the profile is associated with when outputting textual communications in audible form. For example, in an embodiment, a new voice profile for an individual may output textual communications from that individual in a voice that is robotic. Conversely, a voice profile for an individual that has been frequently updated may output textual communications in a voice resembling that of the individual. In an embodiment, updating the voice profile may involve introducing subsequent voice inputs from a user associated with the voice profile. For example, each time a user has a telephone conversation with another individual for whom a voice profile has been created, an embodiment may use the voice inputs transmitted by the individual to update the voice profile associated with that individual.

In an embodiment, a voice profile may be generated for a user that may be updated whenever the user transmits any type of voice input (e.g., telephone conversations, recordings, vocal notes, etc.) to the device. For example, each time a user calls any individual on his or her contact list, an embodiment may use the voice input from the user during the call to update the user's voice profile. In an embodiment, the user's voice profile may be stored at a storage location that is accessible by the device (e.g., locally or through cloud storage). In an embodiment, the voice profile of a user may be shared with the devices of other users automatically or through user designation. For example, in an embodiment, the voice profile of a user may be automatically sent to the device of another user based upon the detection of a predefined event (e.g., when the other user is added to the user's contact list, or vice versa). In another example, a user may upload their voice profile to a storage location (e.g., cloud storage) where it is accessible for download by other users.

In an embodiment, when a textual communication is received on a user's device, the textual communication may be associated with the voice profile of the sender. For example, when a text message is received from the stored contact, Meghan Smith, only the voice data associated with Meghan Smith's corresponding voice profile may be used to vocally output the text message. This ensures that an embodiment does not access the incorrect voice profile when outputting the textual communication.

At 303, an embodiment may provide output to a user for a received textual communication in a voice resembling the voice of the sender of the textual communication. In an embodiment, the output may comprise text-to-speech vocal output that audibly recites (e.g., through a speaker on a device) the contents of the received textual communication. In an embodiment, output may be audibly recited in the sender's voice by using the voice data in the sender's corresponding voice profile. For example, when a text message is received from the contact, Meghan Smith, that states, “Hello, how are you?” an embodiment may access the voice profile associated with Meghan Smith to audibly recite the aforementioned phrase in a voice that resembles that of Meghan Smith.

In an embodiment, a device may output the received text data automatically upon receipt. In some situations it may be advantageous for an embodiment to output the received text data upon receiving the text data. For example, in situations where a user may not be able to visually inspect their device (e.g., while driving), it may be advantageous for an embodiment to automatically output the contents of the received text to the user. Alternatively, in other situations a user may not want a received textual communication to be audibly output (e.g., while in a business meeting). Therefore, in an embodiment, a user may enable/disable automatic text-to-speech functions across the system. Alternatively, in an embodiment, a user may enable/disable automatic text-to-speech functions for a particular user. For example, a user may enable automatic text-to-speech functions for the contact Meghan Smith only.

As will be understood from the description provided herein, an embodiment tunes a voice model to replicate a particular user's speech characteristics such that audio output provided is more similar to the particular user's speech sound. This may be applied to text-to-speech systems as well as any other system in which machine generated human vocal output is used. For example, an embodiment may be employed to provide synthesized speech output that resembles a particular user in navigation systems, kiosks, etc.

The various embodiments described herein thus represent a technical improvement to conventional text-to-speech systems and/or systems that produce human vocal outputs. Using the techniques described herein, a user may be able to immediately identify the identity of a sender of a textual communication. An embodiment provides output of any received textual communications to a user in the textual communication sender's voice.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to produce voice output;
identifying, using a processor, a voice profile;
generating, using a processor, the voice output, said voice output being tuned based on the voice profile; and
providing, using a speaker, the voice output.

2. The method of claim 1, further comprising receiving text data, wherein the voice profile is associated with a user sending the text data.

3. The method of claim 2, wherein the providing comprises providing output after receiving the text data.

4. The method of claim 2, wherein the text data is derived from a communication selected from the group consisting of: a text message, an email, and a social media notification.

5. The method of claim 1, further comprising collecting voice input from a user and generating a voice profile using the voice input of the user.

6. The method of claim 5, comprising updating the voice profile based upon subsequent voice inputs.

7. The method of claim 1, wherein the voice profile is received at the information handling device from another device.

8. The method of claim 1, wherein the voice profile is stored at a storage location accessible by the information handling device.

9. The method of claim 1, comprising automatically generating a voice profile for each user added to a user's contact list.

10. The method of claim 1, comprising sending, based upon a predefined event, a voice profile of to another device.

11. An information handling device, comprising:
a processor;
a speaker;
a memory device that stores instructions executable by the processor to:
receive an indication to produce voice output;
identify a voice profile;
generate the voice output, said voice output being tuned based on the voice profile; and
provide the voice output.

12. The information handling device of claim 11, wherein the instructions are executable by the processor to receive text data, wherein the voice profile is associated with a user sending the text data.

13. The information handling device of claim 12, wherein the voice output is provided after receiving the text data.

14. The information handling device of claim 12, wherein the text data is derived from a communication selected from the group consisting of: a text message, an email, and a social media notification.

15. The information handling device of claim 11, wherein the instructions are executable by the processor to collect voice input from a user and generate a voice profile using the voice input of the user.

16. The information handling device of claim 15, wherein the instructions are executable by the processor to update the voice profile based upon subsequent voice inputs.

17. The information handling device of claim 11, wherein the voice profile is received at the information handling device from another device.

18. The information handling device of claim 11, wherein the voice profile is stored at a storage location accessible by the information handling device.

19. The information handling device of claim 1, wherein the instructions are executable by the processor to automatically generate a voice profile for each user added to a user's contact list.

20. A product, comprising:
a storage device that stores code, the code being executable by a processor and comprising:
code that receives an indication to produce voice output;
code that identifies a voice profile;
code that generates the voice output, said voice output being tuned based on the voice profile; and
code that provides the voice output.
